(19) United States
(12) Patent Application Publication
(10) Pub. No.: US 2009/0271803 A1
(43) Pub. Date: Oct. 29, 2009

(54) METHOD FOR PROVIDING DYNAMIC INFORMATION WITH A MOUSE POINTER IN A GRAPHICAL USER INTERFACE

(75) Inventors: Yonatan Maman, Hof Hacarmel (IL); Yossi Mesika, Afula (IL)

Correspondence Address: KEUSEY, TUTUNJIAN & BITETTO, P.C., 20 CROSSWAYS PARK NORTH, SUITE 210, WOODBURY, NY, 11797, US

(73) Assignee: INTERNATIONAL BUSINESS MACHINES CORPORATION, ARMONK, NY (US)

(21) Appl. No.: 12/109,702

(22) Filed: Apr. 25, 2008

(51) Int. Cl. G06F 9/46

(52) U.S. Cl. 719/318

(57) ABSTRACT

A method for presenting dynamic information to the user in conjunction with a mouse pointer in a graphical user interface is provided. The dynamic information is generated by applications and services that would like to notify the user about various events. Once a configuration is loaded, events from applications are waited upon. Upon receipt of an event from an application, the system determines if the event is to be displayed, and when it is, processes the event and prepares an event message to be displayed. The event message is then displayed next to the mouse pointer without interfering with the user's current activity. The event message can take the form of an icon, graphic, text or a combination of any one or more of the above.

### BACKGROUND

1. Technical Field

The present invention relates to graphical user interfaces (GUIs). More particularly, it relates to a method for providing dynamic information to a user in conjunction with a mouse pointer.

2. Description of the Related Art

Generally speaking, the mouse pointer in the graphical user interface (GUI) of any operating system (OS) is the graphical object that is closest to the focus of users most of the time. The mouse pointer is used for most usual tasks by moving it across the screen(s) from one place to another.

Currently, the mouse pointer displays only those images taken from a set of predefined static images that represent the context where the mouse pointer is placed. For example, when using a program having a plurality of GUI buttons or icons, when the mouse pointer is positioned over one of such buttons a static image of the function of that button, or a text description of that button's function may be displayed in the area of the button or icon.

### SUMMARY

According to one aspect, the mouse pointer is provided with the capability to present to the user not only the static images that are currently available, but to also present a diversity of information that is being generated on the fly (or dynamically) by running applications or the operation system itself.

This and other aspects are achieved according to an implementation of a method for providing dynamic information display with a mouse pointer, wherein the method includes the steps of loading a configuration upon start up of an operating system, waiting for an event to occur in at least one running application, determining whether an event has occurred, determining if the event is to be displayed, preparing an event message corresponding to the event when it is determined to display the event, and displaying the prepared event message next to the mouse pointer being used by the end-user.

Other objects and features of the present principles will become apparent from the following detailed description considered in conjunction with the accompanying drawings. It is to be understood, however, that the drawings are designed solely for purposes of illustration and not as a definition of the limits of the present principles, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The disclosure will provide details in the following description of preferred embodiments with reference to the following figures wherein:

FIG. 1 is flow diagram of the method according to an implementation;

FIG. 2 is an example of a mouse pointer display according to an implementation; and

FIG. 3 is another example of a mouse pointer display according to an implementation.

### DETAILED DESCRIPTION

According to one embodiment, the present invention provides a method that will enable dynamically generated information to be presented/displayed to the user in conjunction with the regular mouse pointer. The dynamic information content will be generated by services that would like to notify the user about various events. Once such an event should be presented to the user, the information will be displayed very close to the place where the mouse pointer is at the moment.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

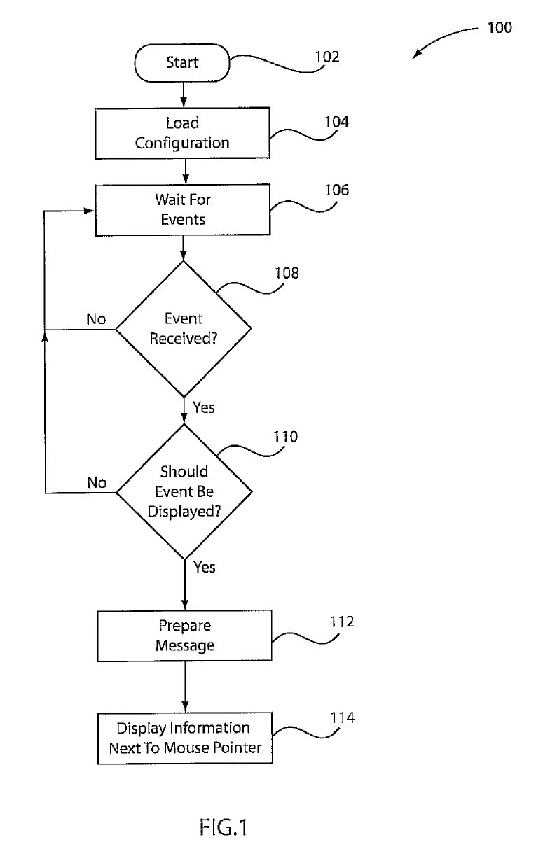

FIG. 1 shows the method 100 according to an implementation. When a system starts 102 (e.g., the operating system is loaded), the configuration is loaded (104) from the persistent layer and it restores the configuration that was present before shutting down the system, or alternatively, a default initial configuration can be loaded (104) when such saved configuration does not exist. Any customization to the configuration by the user will be saved for future use.

The system enters a wait mode (106) where nothing is displayed to the user. Once an event has been received (108) from a running application, the service will extract the information from that event and check to determine if such information should be presented (displayed) to the user (110) (e.g., by checking the configuration for disabled/enabled types of events, etc.).

If the information should be displayed to the user, the service will prepare (112) the information to be displayed (e.g., by shortening the length of the message, attaching an icon, coloring, etc). Once prepared, the information is sent to the graphical renderer unit that will present/display (114) it to the user next to the mouse pointer.

In most instances, the above reference dynamic information display by the mouse pointer will be provided by the operating system (OS)/Windows Manager, and it will be available to the hosted applications. Other options for implementation may include creating an application/service that is running at the background and is responsible for supporting the display properties of the present invention. Those of skill in the art will recognize that such application support will be cross-application, and preferably will not be application specific.

According to the implementation described, the information will be presented next to the mouse pointer in a way that will not interfere with the usual work of the end user, and in a way that will not hide from the user the information on the screen that is below the mouse pointer. For this purpose, it is envisioned to implement the use of semi-opaque colors of the presented information so that graphical elements behind the presented information will still be visible to the end-user.

According to a further implementation, the user will be provided with an option to turn on and off the displayed information with a mouse click (and/or keyboard hotkeys/software configuration). For this purpose, a combination of unique mouse clicks will toggle between the modes. The combination will be configurable and controlled by the end user (e.g., double click on the middle button of the mouse, etc.).

The following are just some examples of how the present invention can be used:

1) The user has a multi-monitor system and works on the desktop that currently does not have the system tray or the task bar (i.e., the one that is not the primary monitor). The user will be notified once an incoming message, from an Instant messaging application, has arrived. The notification will be presented next to the mouse pointer. The user will then be able to go back to the primary monitor and open the incoming message;

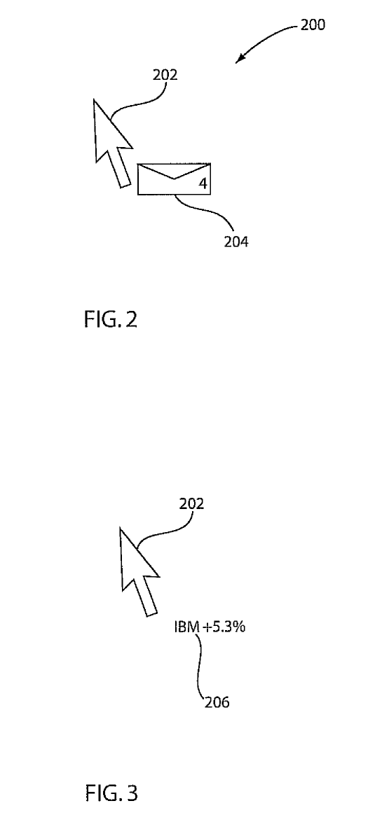

2) The user is working on a remote desktop in full screen mode (using VNC, RDC, VM Player, etc.). The user wants to get notified about various events that occur in the local environment. Therefore, although the user sees the remote desktop, a notification about incoming mail (in the local mail client) will be presented next to the mouse pointer. For example, FIG. 2 shows the pointer 202 with the mail icon/display 204 showing the user that there are 4 unread messages (i.e., in their local mail client);

3) The user starts downloading a file in the browser and opens a different application while the file is being downloaded in the background. The mouse pointer will have a small notification icon when the download is over;

4) An investor may want to get notified once one of his/her portfolio's stocks has a daily change of more than 5% from its opening price. FIG. 3 shows an example of this concept where the display icon 206 shows the stock ticker (e.g., IBM), and a percentage increase of +5.3%. This display can be dynamically changing according to the changing percentage;

5) A Lotus Notes user would like to get a notification whenever a new message reached the inbox; and

6) The user would like to present incoming RSS feeds from a breaking news web site.

As can be seen, there are many implementations and usage scenarios where the mouse pointer display of the present invention will be very useful in informing the end-user of dynamic information and dynamically changing information.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

1. A method for providing dynamic information with a mouse pointer in a graphical user interface, the method comprising the steps of:
loading a configuration of disabled and enabled types of events upon start up of an operating system;
waiting for an event to occur in at least one running application;
determining whether an event has occurred;
determining if the event is to be displayed by identifying an enabled event status in the loaded configuration for the occurring event;
preparing an event message corresponding to the event when it is determined to display the event based on the identified enabled event status in the loaded configuration;
displaying the prepared event message next to the mouse pointer being used by the end-user; and
providing the user with the ability to turn on and off the displayed prepared event message and toggle between modes with a combination of mouse clicks.
